(19) United States
(12) Patent Application Publication
(10) Pub. No.: US 2014/0344309 A1
(43) Pub. Date: Nov. 20, 2014

(54) METHOD OF PROVIDING AUTO ID SERVICE ON THE BASIS OF KEYWORD IDENTIFICATION RETRIEVAL

(71) Applicant: Suk-il Park, Seoul (KR)

(72) Inventor: Suk-il Park, Seoul (KR)

(21) Appl. No.: 14/368,908

(22) PCT Filed: Nov. 23, 2012
(86) PCT No.: PCT/KR2012/009979

§ 371 Date: Jun. 26, 2014

(30) Foreign Application Priority Data
Dec. 26, 2011 (KR) 10-2011-0142227

(51) Int. Cl. G06F 17/30

(52) U.S. Cl. CPC G06F 17/30864; G06F 17/30684
USPC 707/772

(57) ABSTRACT

A method of providing an AUTO ID service based on a keyword identification retrieval is provided. The method includes: registering a keyword identification including information about a physical object or an abstract object in a main name server; comparing the keyword identification with at least one keyword identification pre-stored in the main name server to determine whether the keyword identification is a single keyword identification; storing the keyword identification determined as the single keyword identification in a keyword identification database (DB) of the main name server; retrieving at least one of keyword identifications stored in the keyword identification DB the main name server through a wire-wireless terminal that accesses the Internet; transmitting an Internet address comprising information about the corresponding object from the main name server to the wire-wireless terminal in response to the keyword identification transmitted from the wire-wireless terminal; and accessing an information data server corresponding to the Internet address through the wire-wireless terminal to acquire information corresponding to the corresponding keyword identification.

### TECHNICAL FIELD

The present general inventive concept generally relates to providing a method of providing an auto identification (ID) service based on a keyword ID retrieval, and more particularly, to providing a method of providing an auto ID service based on a keyword ID retrieval to integrate and manage a physical object and an abstract object.

### BACKGROUND ART

An automatic identification technology refers to a technology that allocates an object recognition ID to an object and acquires information data about the corresponding object existing in a content server through the object recognition ID. Detailed examples of the automatic identification technology include a radio frequency identification (RFID) technology, 1-dimensional and 2-dimensional bar codes, a fingerprint recognition, a magnetic recognition, an optical recognition, etc.

Representative technologies of the AUTO ID technologies are roughly classified into the 1-dimensional bar code, the 2-dimensional bar code, and the RFID technology

The 1-dimensional bar code is a bar code that is marked with black bars on a white ground and is frequently used in distribution and logistics services, etc., i.e., in a logistics management-centric service.

The 2-dimensional bar code is a braille or mosaic code that expresses information in a square shape. The 1-dimensional bar code expresses information only in a horizontal direction according to thicknesses of bar lines (i.e., bar code density), but the 2-dimensional bar code expresses information both in horizontal and vertical directions. Therefore, the 2-dimensional bar code refers to an image scan type technology that may store high-density information that is 100 times much more than an information capacity (20 bytes) of the 1-dimensional bar code, restore a considerable portion of damaged information, and may be scanned in a direction of 360°. As an example of the 2-dimensional bar code, there may be a quick response (QR) code that provides an information user-centric service through a smartphone

The RFID technology is a cutting-edge technology of the AUTO ID technologies and is an unbonded technology in terms of recognition distance. Therefore, the RFID technology may replace a bar code system.

The AUTO ID technologies have evolved into new types of technologies with the development of Internet search technologies, web browser terminals, etc. In other words, a logistics management-centric 1-dimensional bar code has been replaced with a 2-dimensional bar code with the advent of smartphones, and the RFID technology has produced web standards similar to a web service system. As described above, standards of a logistic-centric RFID technology and an information user-centric mobile service have been modified.

However, existing AUTO ID technologies as described above have merits but are restricted in terms of technologies and services that will be described below.

The 1-dimensional bar code is applied only to logistics management, and thus an application area thereof is limited. The 2-dimensional bar code provides all services to a portable terminal of an information user with the advent of smartphones but is limited in terms of wired and wireless internetworking services and thus is inferior to the RFID technology to dissolve technical problems such as a recognition distance, the number of recognition objects, etc.

The RFID technology has a limit to a wide use application due to a cost problem of an electronic tag mediating IDs. This is because an additional electronic tag recognizer is not installed in a portable phone (e.g., a smartphone) of a general user, and thus information services that may be provided to ordinary persons are limited.

As a result, objects that are managed through the existing AUTO ID technologies described above are limited only to concretely existing objects, i.e., physical objects. Therefore, it is difficult to integrate and manage physical objects and abstract objects such as formless information, contents, etc.

The fundamental reason is as follows. The existing AUTO ID technology is a system that directly attaches a medium for checking an ID of an object to a physical object to check the physical object. Therefore, it is impossible to manage a formless abstract object to which the medium for checking the ID is not attachable.

For another reason, the physical object and the abstract object are currently separated from each other to be managed under different technical systems and systems.

Therefore, it is difficult to integrate and manage the physical object and the abstract object by using the existing AUTO ID technology. Also, this problem becomes an obstacle to realizing a ubiquitous society.

### DETAILED DESCRIPTION OF THE INVENTION

### Technical Problem

The exemplary embodiments provide a method of providing an AUTO ID service based on a keyword identification retrieval to provide a keyword identification including a natural language, which may allocate an ID to both a physical object and an abstract object, and realize the keyword identification in order to enable a web search for the physical object and the abstract object through a normal Internet search so as to integrate and manage the physical object and the abstract object.

### Technical Solution

According to an aspect of the exemplary embodiments, there is provided a method of providing an AUTO ID service based on keyword identification retrieval. The method may include: registering a keyword identification including information about a physical object or an abstract object in a main name server; comparing the keyword identification with at least one keyword identification pre-stored in the main name server to determine whether the keyword identification is a single keyword identification; storing the keyword identification determined as the single keyword identification in a keyword identification database (DB) of the main name server; retrieving at least one of keyword identifications stored in the keyword identification DB the main name server through a wire-wireless terminal that accesses the Internet; transmitting an Internet address comprising information about the corresponding object from the main name server to the wire-wireless terminal in response to the keyword identification transmitted from the wire-wireless terminal; and accessing an information data server corresponding to the Internet address through the wire-wireless terminal to acquire information corresponding to the corresponding keyword identification.

The keyword identification may include an information producer ID, an information data ID subordinate to the information producer ID, a fully qualified domain name (FQDN) corresponding to the information producer ID, and a lower address corresponding to the information data ID.

The information producer ID and the information data ID may include one of a natural language, a number, and symbols that are input through a keyboard or combinations thereof

The lower address may include a source name indicating a webpage name or comprises a file directory connected to the FQDN and the source together.

After registering the keyword identification, the method may further include: transmitting the keyword identification to an information producer name server accessing the main name server to register the keyword identification in the main name server.

A lower address of the keyword identification registered in the main name server may have a NULL value, and a lower address of the keyword identification registered in the information producer name server may have one of a source name, a combination of a file directory connected to the FQDN and the source name, and a NULL value.

After retrieving the at least one of the keyword identification, the method may further include: requesting an URL corresponding to the keyword identification from an information name server that accesses the main name server.

After requesting the URL corresponding to the keyword identification from the information name server, the method may further include: in response to the lower address of the keyword identification being registered in the information producer name server and having the NULL value, requesting a URL corresponding to the keyword identification from a lower name server that accesses the information producer name server. The lower address of the keyword identification registered in the lower name server may include one of a source name and a combination of a file directory connected to the FQDN and the source name.

### Advantageous Effects

In the present general inventive concept as described above, an AUTO ID area may extend based on a keyword identification, and objects may be managed through the Internet to early realize a ubiquitous world through a retrieval-based fusion on the Internet. Also, an AUTO ID area into which an AUTO ID technology and a web search technology are combined may be created.

Also, an existing RFID technology restrictions on application areas and users due to additional technologies such as a tag and a reader, and other AUTO ID technologies are not related to natural language processing web search technologies. However, according to the present general inventive concept, a keyword identification formed of letters and numbers or symbols belonging to a natural language may be allocated to an information object to provide an information service regardless of types of terminals under wired and wireless Internet conditions. Therefore, the present general inventive concept may overcome a terminal restriction of the existing AUTO ID technology.

In addition, the existing AUTO ID technology is limited to information provider-centric application cases. However, according to the present general inventive concept, anyone may allocate a keyword identification to information data of anyone, and thus the public may generate information data to which a keyword identification is allocated.

### DESCRIPTION OF THE DRAWINGS

FIG. 1 is a schematic view illustrating an AUTO ID system based on a keyword identification retrieval according to an exemplary embodiment of the present general inventive concept.

FIG. 2 is a flowchart illustrating a method of providing a service by using an AUTO ID system based on a keyword identification retrieval according to an exemplary embodiment of the present general inventive concept.

FIG. 3 is a flowchart illustrating a method of providing a service by using an AUTO ID system based on a keyword identification retrieval, according to another exemplary embodiment of the present general inventive concept.

### BEST MODE OF THE INVENTION

Exemplary embodiments are described in greater detail with reference to the accompanying drawings.

Hereinafter, an AUTO ID system and a method of providing a service based on a keyword identification retrieval according to an exemplary embodiment of the present general inventive concept will be described with reference to the attached drawings. However, if it is determined that detailed descriptions of well-known arts related to the present general inventive concept obscure the exemplary embodiments with unnecessary detail in the description of the present general inventive concept, the detailed descriptions are not described.

An AUTO ID system based on a keyword identification retrieval according to the present general inventive concept includes an information producer terminal 1, a main name server 3, an information user terminal 5, an information producer name server 7, an information data server 9, and a plurality of lower name servers 11 and 13. The information producer terminal 1 and the information user terminal 5, and the main name server 3, the information producer name server 7, the information data server 9, and the lower name servers 11 and 13 will be described as being connected to one another through the Internet.

The information producer terminal 1 and the information user terminal 5 are apparatuses that access to the Internet through a wire, wireless, or wired and wireless terminal (e.g., a computer, a portable phone (smartphone), a tablet PC, or the like) to retrieve information and display the retrieved information.

The main name server 3 receives a keyword identification from the information producer terminal 1 before the keyword identification is registered and compares the received keyword identification with keyword identifications, which are stored and registered in a keyword identification database (DB) of the main name server 3, to determine whether there is an overlapping keyword identification.

In this case, if the unregistered keyword identification is not registered in the keyword identification DB, the main name server 3 stores the unregistered keyword identification in the keyword identification DB and informs the information producer terminal 1 that the registering of the keyword identification is completed.

The keyword identification may correspond to a physical object or an abstract object. Here, the physical object corresponds to an object of a type that may be managed through a 1-dimensional bar code, a 2-dimensional bar code, an RFID technology, or the like.

Also, in the present general inventive concept, in order to manage physical objects, a medium for checking an identification may be a preset printed matter on which a keyword identification corresponding to a corresponding object is printed. The abstract object indicates formless information and allocates a keyword identification corresponding to the corresponding formless information like the physical object so as integrate and manage the physical object and the abstract object.

The keyword identification includes an information producer ID, an information data ID, first address information, and second address information.

The information producer ID is formed of symbols that may be input through a general-purpose input device such as letters, numbers, or a keyboard or combinations thereof.

Like the information producer ID, the information data ID is formed of symbols that may be input through an input device such as letters, numbers, or a keyboard. The information data ID may include a plurality of pieces of dependent data of a single information producer ID. In this case, one piece of information data ID has a uniqueness under the information producer ID.

The first address information includes a host name (e.g., www) and a domain name (e.g., hj.com) as a fully qualified domain name (FQDN) corresponding to the information producer ID.

The second address information is a lower address that is connected to the FQDN. The lower address includes a source name (a webpage name) or includes a file directory connected to the FQDN and the source name (the webpage name).

The keyword identification is stored in the keyword identification DB of the main name server 3 and in the information producer name server 7. Here, the second address information of the keyword identification may have an effective value (or a lower address) or a NULL value according to an amount of information that may be provided by an information producer.

In this case, if the second address information of the keyword identification is stored as the NULL value in the main name server 3, the second address information of the keyword identification is input as the NULL value into the information producer name server 7. However, the second address information of the keyword identification may be revised by a manager of the information producer name server 7 to have an effective value.

The input of the second address information is not limited to required conditions for the following reasons. If an amount of information that may be provided by a single information producer is higher than or equal to thousands of cases, and there is a response to requests of a plurality of information user terminals 5 for inquiring a keyword identification, the information producer name server 7 may be induced to inquire the keyword identification in order to distribute load applied to the main name server 3. In this case, the information producer name server 7 may distribute the load to the lower name servers 11 and 13 according to the same method.

For example, if an information producer operates a private homepage or blog, the number of pieces of provided information mainly corresponds to about dozens of pieces or hundreds of pieces. In this case, the information producer inputs the second address information, i.e., the lower address, into the main name server 3 when registering the keyword identification. Therefore, if the keyword identification is inquired through the information user terminal 5, the main name server 3 may directly provide address information of the corresponding keyword identification.

However, if the information producer is a newspaper company that provides a large amount of information, the information producer leaves the second address information as the NULL value without inputting the second address information when setting keyword identifications to correspond to a plurality of articles stored in an information data server of the newspaper company. In this case, if the information producer inquires the keyword identification, of which the second address information is the NULL value, from the information user terminal 5, the main name server 3 requests address information, in which information corresponding to the keyword identification is positioned, from the information producer name server 7 with reference to the first address information of the keyword identification. In this case, an IP address of the lower name server 11 is pre-stored in the keyword identification DB of the information producer name server. The information producer checks whether the second address information corresponding to the keyword identification exists in the lower name server 11 and, if the second address information exists, the information producer transmits a URL to the information producer name server 7, and the information producer name server 7 transmits the URL to the name main server 3. In this case, if the second address information of the corresponding keyword identification does not exist in the lower name server 11 or the corresponding URL is deleted, the information producer may transmit an error message to the information producer name server 7.

The keyword identification may further include fields, such as a keyword identification registration date, a registrant (an owner of the keyword identification), etc., besides the information producer ID and the information data ID.

The information producer name server 7 stores and manages the keyword identification that is registered in the main name server 3 by each information producer. In this case, the second address information stored in the information producer name server 7 as described above may be revised to be different from second address information of a keyword identification stored in the main name server 3.

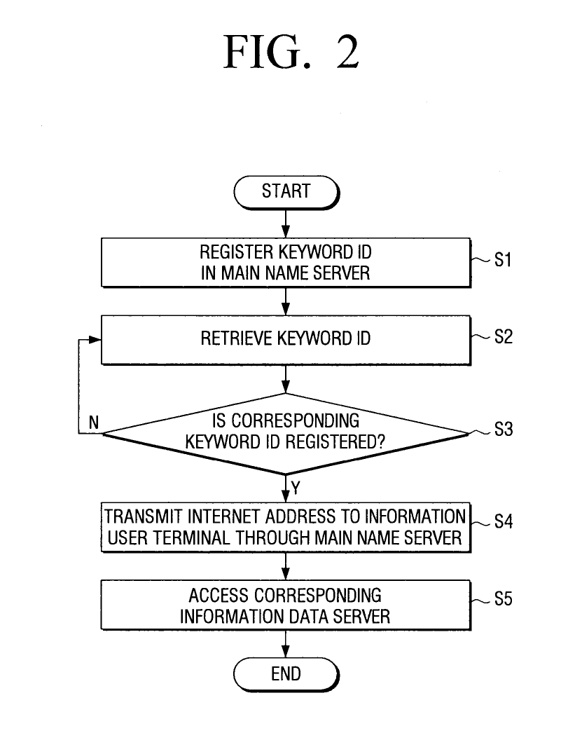

A method of providing a service by using an AUTO ID system based on a keyword identification retrieval according to an exemplary embodiment of the present general inventive concept will now be described with reference to FIG. 2.

In operation S1 , an information producer registers a keyword identification in the main name server 3 through the information producer terminal 1. The keyword identification that is to be registered has information as shown in Table 1 below.

TABLE 1

| | | | Second | | |
|---|---|---|---|---|---|
| Information Producer | Information | First Address | Address | | Registration |
| ID | Data ID | Information | Information | Registrant | Date |
| Hyeon-ju's | Apartment | http://hj.com | homepage/docs/pr/apart.htm | Hyeon-ju | 2011.12.15 |
| | | | | Apartment | |

In this case, the main name server 3 compares an information producer ID of the keyword identification that is to be registered, with an information producer ID of a keyword identification registered in a keyword identification DB of the main name server 3 to check whether the keyword identification has a uniqueness (overlapping) and, if the keyword identification has the uniqueness, newly registers the keyword identification in the keyword identification DB and informs the information producer terminal 1 of whether the keyword identification is registered.

The information producer accesses the information producer name server 7 through the information producer terminal 1 to input the keyword identification into a keyword identification DB of the information producer name server 7. In this case, the information producer may not directly input the keyword identification into the information producer name server 7, and the main name server 3 may register the keyword identification and then transmit the keyword identification to the information producer name server 7.

After the registering of the keyword identification is completed as described above, an information user inputs an identifier identifying an information producer ID and an information data ID of the keyword identification such as “Hyeon-ju's Apartment” as a space onto a search window of an Internet web browser through the information user terminal 5 in operation S2. In this case, the identifier may be set to select various types of symbols (e.g., +, |, _, etc.) instead of the space.

If the information user terminal 5 transmits the input keyword identification to the main name server 3 and requests a Uniform Resource Locator (URL) corresponding to the corresponding keyword identification, the main name server 3 inquires the input keyword identification from a keyword identification DB of the main name server 3 in operation S2.

In operation S3, the main name server 3 determines whether the corresponding keyword identification exists in the keyword identification DB of the main name server 3.

If the corresponding keyword identification exists, the name server 3 transmits first address information and second address information respectively corresponding to an information producer ID and an information data ID, i.e., URL(http://hj.com/homepate/docs/pr/apart.htm) desired by an information user, to the information user terminal 5 in operation S4. On the contrary to this, if the corresponding keyword identification does not exist, the name server 3 transmits an error message to the information user terminal 5.

In operation S5, the information user terminal 5 accesses the information data server 9 by using an URL corresponding to the inquired keyword identification. In this case, the information data server 9 transmits corresponding information to the information user terminal 5.

In the above-described case, an amount of information provided by the information producer is input to the second address information of the keyword identification registered in the main name server 3.

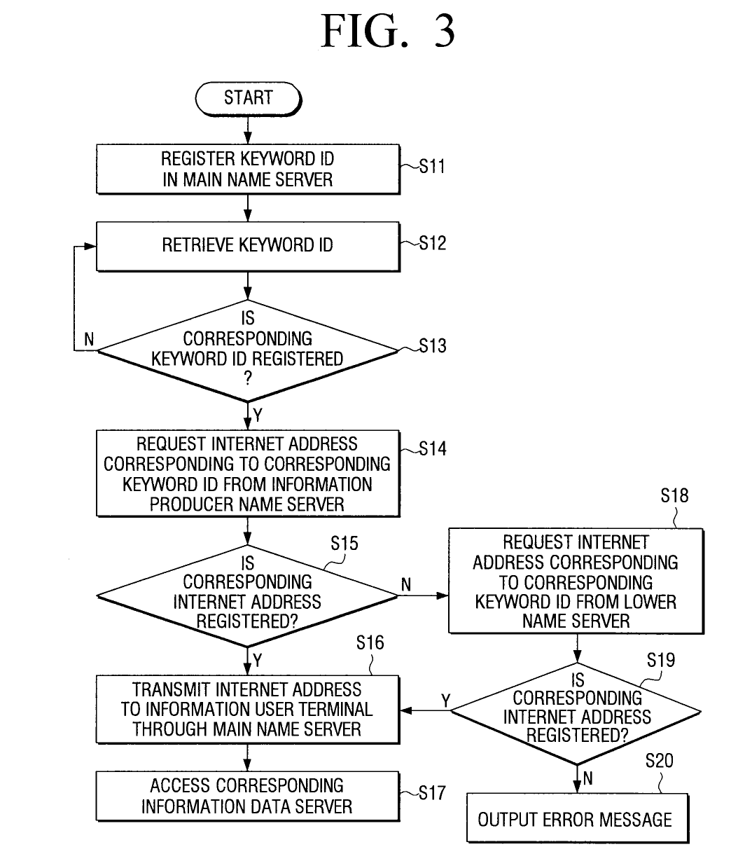

A method of providing a service of an AUTO ID system based on a keyword identification retrieval if an information producer provides a large amount of information will now be described with reference to FIG. 3.

In operation S11, a keyword identification is registered in the main name server 3 through the information producer terminal 1. In operation S12, the keyword identification is searched through the information user terminal 5. Operation S13 of determining whether the corresponding keyword identification is registered is the same as the exemplary embodiment described with reference to FIG. 2. However, when registering the keyword identification, inputting of second address information is omitted to leave the second address information as a NULL value.

In operation S14, the main name server 3 determines whether the corresponding keyword identification exists in a keyword identification DB of the main name server 3 and, if the corresponding keyword identification exists, requests an URL corresponding to the keyword identification from the information producer name server 7.

In this case, the information producer name server 7 determines whether a keyword identification corresponding to the keyword identification requested by the main name server 3 exists in a keyword identification DB of the information producer name server 7 in operation S15.

If the corresponding keyword identification exists, the information producer name server 7 transmits first address information and second address information respectively corresponding to an information producer ID and an information data ID, i.e., a URL desired by an information user, to the information user terminal 5 through the main name server 3 in operation S16. The information user terminal 5 accesses the information data server 9 by using the URL corresponding to the inquired keyword identification in operation S17 to receive desired information from the information data server 9.

If the second address information of the keyword identification stored in the information producer name server 7 is a NULL value, the information producer name server 7 requests a URL corresponding to the keyword identification from the lower name server 11 in operation S18. In this case, an IP address of the lower name server 11 is pre-stored in the keyword identification DB of the information producer name server 7.

In operation S19, the lower name server 11 checks whether second address information corresponding to the keyword identification exists in the lower name server 11. If the second address information exists in the lower name server 11, the lower name server 11 transmits the URL to the information producer name server 7, and the information producer name server 7 transmits the URL to the main name server 3.

Here, if the second address information of the corresponding keyword identification does not exist in the lower name server 11 or is deleted from the lower name server 11, the lower name server 11 transmits an error message to the information producer name server 7 in operation S20.

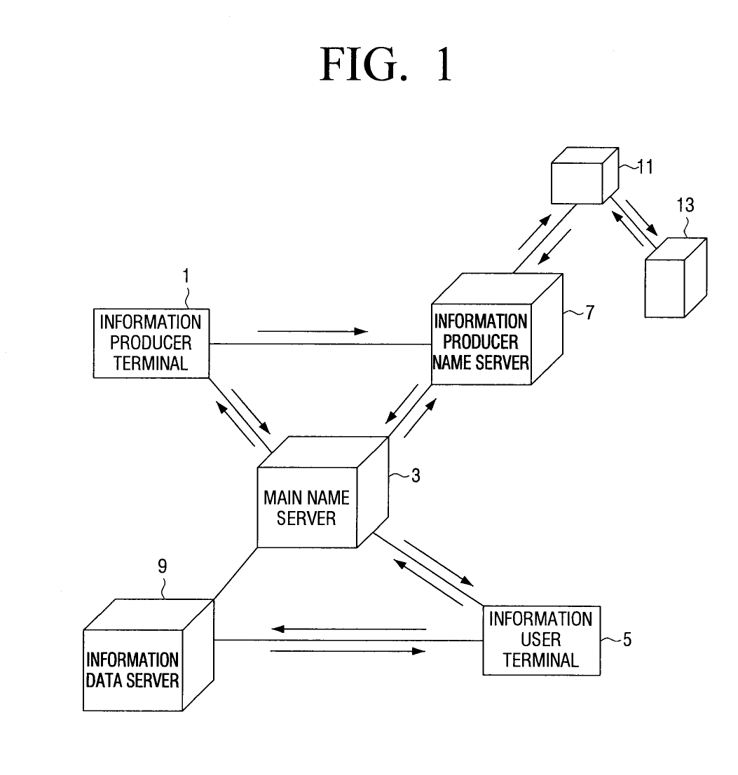

The lower name server 11 may access the lower name server 13 that is subordinate thereto as shown in FIG. 1. This may be hierarchically added if there is a large amount of information that is handled.

As described above with reference to FIGS. 2 and 3, an abstract object (information) is serviced, but the present general inventive concept is not limited thereto. A keyword identification of a physical object (product) may be registered, and then the same service may be provided according to the same method as described above.

According to the present general inventive concept as described above, an AUTO ID area may extend based on a keyword identification, and objects may be managed through the Internet to early realize a ubiquitous world through a retrieval-based fusion on the Internet. Also, a new AUTO ID area in which an AUTO ID technology and a web search technique are combined may be created.

Also, an existing RFID technology is restricted to application areas and users due to additional technologies such as a tag and a reader, and other AUTO ID technologies are not related to natural language processing web search technologies. However, according to the present general inventive concept, a keyword identification formed of letters and numbers or symbols belonging to a natural language may be allocated to an information object to provide an information service regardless of types of terminals under wired and wireless Internet conditions. Therefore, the present general inventive concept may overcome a terminal restriction of the existing AUTO ID technology.

In addition, the existing AUTO ID technology is limited to information provider-centric application cases. However, according to the present general inventive concept, anyone may allocate the keyword identification to information data of anyone, and thus the public may generate information data to which a keyword identification is allocated.

The present general inventive concept as described above may be applied regardless of natural conditions such as temperature, humidity, moisture, etc. and may also be applied to an auditory object (e.g., music) and a visual object (e.g., a moving picture or the like broadcast on a TV) of abstract objects. Also, keyword identifications may be allocated to invisible abstract objects, i.e., social groups such as Social Network Service (SNS) such as Facebook, Twitter, etc. or abstract objects such as particular spiritual values, etc. to extend an application area of an AUTO ID.

Also, a keyword identification is printed in and copied into a detailed object, and thus cost for allocating IDs may be greatly reduced, and only a space for inputting the keyword identification may be secured for object spaces for allocating the IDs. Therefore, an AUTO ID may be applied into an area in which a space for allocating an ID is not secured.

According to a characteristic of the keyword identification of the present general inventive concept, IDs may be allocated to logistics to enable a Business to Business (BtoB) service referred to as a logistics management and a Business to Consumer (BtoC) service referred to as contacts between consumers and information objects through the same keyword identification.

An information user may conveniently acquire corresponding information through a keyword identification allocated to an object anytime anywhere by managing objects through the Internet based on a retrieval technology.

In the above-described exemplary embodiments of the present general inventive concept, an information user directly inputs letters onto a search window of an Internet web browser through the information user terminal 5 to retrieve information but is not limited thereto. Therefore, the information user may indirectly input the letters through a letter recognition scanner (not shown).

In this case, the letter recognition scanner may include a camera module (not shown) that is installed in a part of the information user terminal 5 and a normal letter recognition program (software) that recognizes an image read by the camera module as letters to convert the letters into corresponding text data. The camera module may be a camera that is preset in the information user terminal 5.

Also, to input the letters through the letter recognition scanner, a selection area may be displayed around the search window of the Internet web browser to select a letter recognition input method. The selection area may be expressed in an image form such as a normal summit button that may be displayed on the web browser. In this case, if a user clicks or touches the selection area (i.e., the information user terminal 5 uses a capacitive display panel), a web browser displayed on the information user terminal 5 may switch over to a capturing mode to capture letters.

Here, the letters that are captured may be letters that are printed on advertisement. A keyword identification of the letters may be pre-registered in the main name server 3 by an information producer.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

### INDUSTRIAL APPLICABILITY

The present general inventive concept provides a method of providing auto identification service based on a keyword identification retrieval to integrate and manage a physical object and an abstract object. Therefore, the present general inventive concept may be applied to a system and a service for providing information through a communication network.

What is claimed is:

1. A method of providing an AUTO ID service based on keyword identification retrieval, the method comprising:
registering a keyword identification comprising information about a physical object or an abstract object in a main name server;
comparing the keyword identification with at least one keyword identification pre-stored in the main name server to determine whether the keyword identification is a single keyword identification;
storing the keyword identification determined as the single keyword identification in a keyword identification database (DB) of the main name server;
retrieving at least one of keyword identifications stored in the keyword identification DB the main name server through a wire-wireless terminal that accesses the Internet;
transmitting an Internet address comprising information about the corresponding object from the main name server to the wire-wireless terminal in response to the keyword identification transmitted from the wire-wireless terminal; and
accessing an information data server corresponding to the Internet address through the wire-wireless terminal to acquire information corresponding to the corresponding keyword identification.

2. The method of claim 1, wherein the keyword identification comprises an information producer ID, an information data ID subordinate to the information producer ID, a fully qualified domain name (FQDN) corresponding to the information producer ID, and a lower address corresponding to the information data ID.

3. The method of claim 2, wherein the information producer ID and the information data ID comprise one of a natural language, a number, and symbols that are input through a keyboard or combinations thereof.

4. The method of claim 2, wherein the lower address comprises a source name indicating a webpage name or comprises a file directory connected to the FQDN and the source together.

5. The method of claim 2, after registering the keyword identification, further comprising:
transmitting the keyword identification to an information producer name server accessing the main name server to register the keyword identification in the main name server.

6. The method of claim 5, wherein a lower address of the keyword identification registered in the main name server has a NULL value, and a lower address of the keyword identification registered in the information producer name server has one of a source name, a combination of a file directory connected to the FQDN and the source name, and a NULL value.

7. The method of claim 6, after retrieving the at least one of the keyword identification, further comprising:
in response to the lower address of the keyword identification requesting an URL corresponding to the keyword identification from an information name server that accesses the main name server.

8. The method of claim 7, after requesting the URL corresponding to the keyword identification from the information name server, further comprising:
in response to the lower address of the keyword identification being registered in the information producer name server and having the NULL value, requesting a URL corresponding to the keyword identification from a lower name server that accesses the information producer name server.

9. The method of claim 8, wherein the lower address of the keyword identification registered in the lower name server comprises one of a source name and a combination of a file directory connected to the FQDN and the source name.
